(19) United States
(12) Patent Application Publication
(10) Pub. No.: US 2023/0349945 A1
(43) Pub. Date: Nov. 2, 2023

(54) INERTIAL SENSOR AND INERTIAL MEASUREMENT UNIT

(71) Applicant: SEIKO EPSON CORPORATION, Tokyo (JP)

(72) Inventors: Teruo Takizawa, Matsumoto-shi (JP); Shota Kigure, Matsumoto-shi (JP)

(21) Appl. No.: 18/306,379

(22) Filed: Apr. 25, 2023

(30) Foreign Application Priority Data
Apr. 27, 2022 (JP) 2022-073038

(51) Int. Cl. G01P 15/125; G01P 15/18

(52) U.S. Cl. CPC G01P 15/125; G01P 15/18; G01P 2015/0845

(57) ABSTRACT

An inertial sensor includes: a base body; a sensor element provided at the base body; and a lid body covering the sensor element. The sensor element includes a anchor fixed to the base body, a movable body swingable about a first axis, which is horizontal to the base body, as a swing axis, a first rotation spring and a second rotation spring coupling the anchor and the movable body, a movable comb electrode group provided at the movable body, a fixed comb electrode group provided at the base body and facing the movable comb electrode group, a first inspection electrode provided at the movable body, and a second inspection electrode provided at the base body or the lid body and overlapping the first inspection electrode in a plan view. In the plan view, the first inspection electrode is provided with a plurality of damping adjustment holes.

The present application is based on, and claims priority from JP Application Serial Number 2022-073038, filed Apr. 27, 2022, the disclosure of which is hereby incorporated by reference herein in its entirety.

### BACKGROUND

### 1. Technical Field

The present disclosure relates to an inertial sensor and an inertial measurement unit including the inertial sensor.

### 2. Related Art

In recent years, as an example of a physical quantity sensor, an acceleration sensor and an angular velocity sensor using a silicon micro electro mechanical system (MEMS) technique have been developed. For example, JP-A-2019-23614 discloses an acceleration sensor including a movable rotor that rotates from a substrate plane when an accelerometer moves with an acceleration component perpendicular to the substrate plane. According to JP-A-2019-23614, the acceleration sensor includes a rotor formed of a seesaw frame. Two rotor bars in a longitudinal direction of the rotor include one or more first deflection electrodes, and second deflection electrodes are fixed and overlap each other on an inner package plane above and/or below the one or more first deflection electrodes. The acceleration sensor may perform a self-inspection by applying a test voltage to at least one first deflection electrode and at least one second deflection electrode.

In such an acceleration sensor, the level of noise in a stationary state is high, which may affect resolution and accuracy of operation detection. Generally, in an acceleration sensor using a silicon MEMS, it is known that Brownian noise caused by a sensor element is dominant, and it is important to reduce the Brownian noise. Brownian noise depends on damping of the element by the power of ½, and therefore, an acceleration sensor element with reduced damping is required.

However, in the acceleration sensor of JP-A-2019-23614, since the first deflection electrode is provided, the damping is large, and thus there is a possibility that noise characteristics are deteriorated.

That is, an inertial sensor and an inertial measurement unit capable of easily inspecting a movable body without deteriorating noise characteristics are required.

### SUMMARY

An inertial sensor according to one aspect of the present application includes: a base body; a sensor element provided at the base body; and a lid body covering the sensor element. The sensor element includes a anchor fixed to the base body, a movable body rotatable about a first axis horizontal to the base body, a first rotation spring and a second rotation spring coupling the anchor and the movable body, a movable comb electrode group provided at the movable body, a fixed comb electrode group provided at the base body and facing the movable comb electrode group, a first inspection electrode provided at the movable body, and a second inspection electrode provided at the base body or the lid body and overlapping the first inspection electrode in a plan view of the base body. In the plan view, the first inspection electrode is provided with a plurality of damping adjustment holes.

An inertial measurement unit according to one aspect of the present application includes: the inertial sensor described above; and a controller configured to perform control based on a detection signal output from the inertial sensor.

### BRIEF DESCRIPTION OF THE DRAWINGS

FIG. 1 is a plan view of an inertial sensor according to a first embodiment.

FIG. 2 is a cross-sectional view of the inertial sensor taken along a line b-b of FIG. 1.

FIG. 3 is a perspective view showing a three-dimensional shape of a comb electrode group.

FIG. 4 is a perspective view showing a three-dimensional shape of a comb electrode group.

FIG. 5 is a diagram of a detection principle in a sensor element.

FIG. 6 is an enlarged view of a portion d in FIG. 2.

FIG. 7 is a flowchart showing a flow of an inspection method of a detection function of an acceleration sensor.

FIG. 8 is a plan view of a sensor element according to a second embodiment.

FIG. 9 is a plan view of a sensor element according to a third embodiment.

FIG. 10 is a plan view of a sensor element according to a fourth embodiment.

FIG. 11 is an exploded perspective view of an inertial measurement unit according to a fifth embodiment.

FIG. 12 is a perspective view of a circuit substrate.

### DESCRIPTION OF EXEMPLARY EMBODIMENTS

### First Embodiment

### Configuration of Inertial Sensor

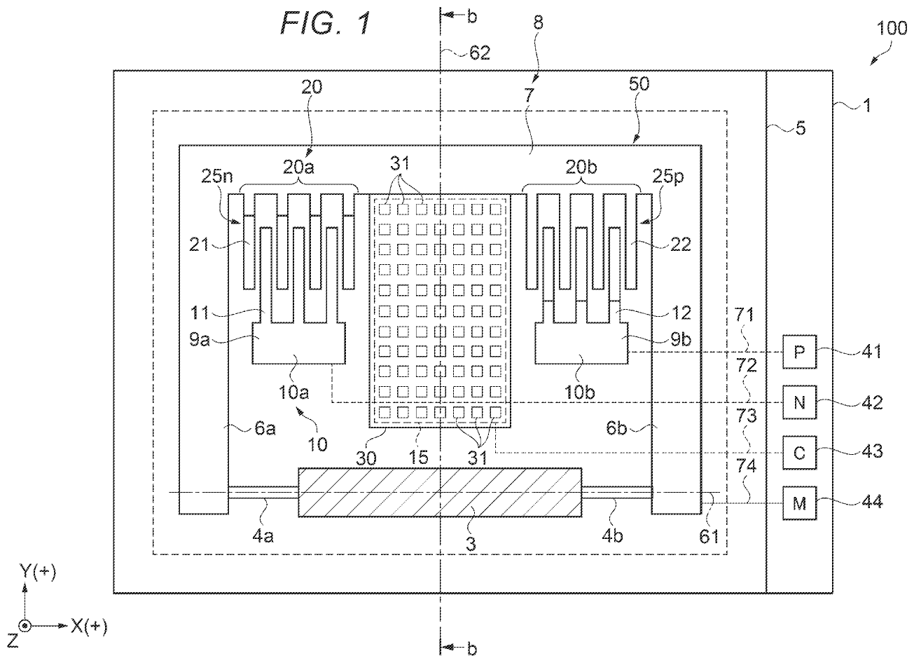

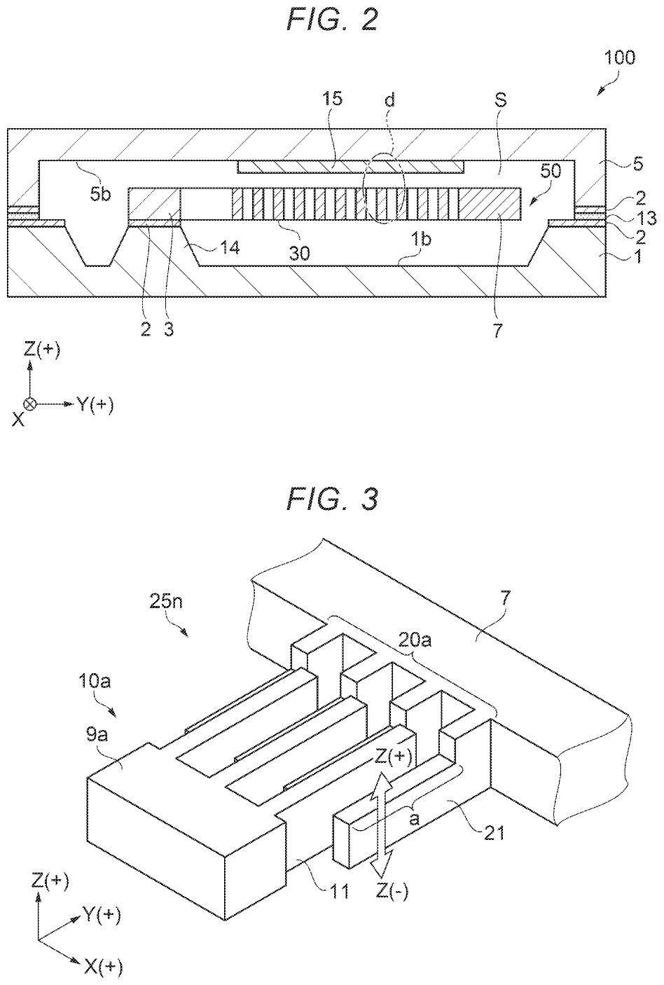

FIG. 1 is a plan view of an inertial sensor according to a first embodiment. FIG. 2 is a cross-sectional view of the inertial sensor taken along a line b-b of FIG. 1.

First, an acceleration sensor 100 shown in FIGS. 1 and 2 will be described as an example of the inertial sensor according to the embodiment. The acceleration sensor 100 is, for example, an acceleration sensor that detects an acceleration in a vertical direction. In each of the drawings, an X axis, a Y axis, and a Z axis, which are three axes orthogonal to one another, are shown. In the embodiment, a Z axis direction is the vertical direction, and the present disclosure is not limited thereto.

The acceleration sensor 100 is a uniaxial acceleration sensor including a MEMS device.

The acceleration sensor 100 includes a base body 1, a sensor element 50 disposed on the base body 1, a lid body 5 covering the sensor element 50, and the like.

As the base body 1, for example, a silicon substrate made of semiconductor silicon or a glass substrate made of a glass material such as borosilicate glass is used. The material is not limited to these materials, and a quartz substrate, a silicon on insulator (SOI) substrate by wafer direct bonding, and the like may be used.

As shown in FIG. 2, the base body 1 made of the SOI substrate is provided with a recess 1b which is dug from a peripheral edge portion thereof. The recess 1b is a portion defining housing space S for housing the sensor element 50. The recess 1b is provided with a protrusion-shaped mount 14 protruding from a bottom surface of the recess 1b.

A anchor 3 of the sensor element 50 is fixed to the mount 14 via an embedded insulating layer 2. In other words, the sensor element 50 is fixed to the base body 1 at the anchor 3. In a preferred example, the anchor 3 is directly bonded to the mount 14.

The sensor element 50 is formed by, for example, etching and patterning a conductive silicon substrate doped with impurities such as phosphorus (P), boron (B), and arsenic (As). In a preferred example, a deep etching technique using a Bosch process is used.

As a preferred example, a silicon substrate is used as the lid body 5. A glass substrate or a ceramic substrate may be used. The lid body 5 is provided with a recess 5b which is dug from a peripheral edge portion thereof. The recess 5b is a portion defining the housing space S for housing the sensor element 50.

In a preferred example, the base body 1 and the lid body 5 are bonded to each other via a glass frit 13 made of low-melting glass. The bonding method may be anodic bonding, or may be activation bonding, diffusion bonding, metal eutectic bonding, and the like.

In a preferred example, the housing space S is filled with an inert gas such as nitrogen, helium, or argon, and hermetically sealed. It is preferable that the housing space S has a substantially atmospheric pressure at a use temperature environment of about −40° C. to 120° C.

As shown in FIG. 1, the sensor element 50 includes the anchor 3, a movable body 8 which is swingable about a swing axis 61, passes through a center of the anchor 3 and extends along the X axis, a first rotation spring 4a and a second rotation spring 4b which couple the anchor 3 and the movable body 8, and the like. The swing axis 61 corresponds to a first axis. In other words, the movable body 8 is swingable about the swing axis 61 as the first axis along the X axis horizontal to the base body 1.

In a preferred example, the first rotation spring 4a and the second rotation spring 4b are torsion springs, and are provided on corresponding two sides of the anchor 3. The first rotation spring 4a, the anchor 3, and the second rotation spring 4b are integrated and disposed on the swing axis 61. In other words, the first rotation spring 4a and the second rotation spring 4b couple the anchor 3 and the movable body 8.

The movable body 8 includes a first bar 6a extending from the first rotation spring 4a in a plus Y direction, a second bar 6b extending from the second rotation spring 4b in the plus Y direction, and a third bar 7 coupling the first bar 6a and the second bar 6b. The plus Y direction corresponds to a first direction. In other words, the movable body 8 includes the first bar 6a extending from the first rotation spring 4a in the first direction, the second bar 6b extending from the second rotation spring 4b in the first direction and paired with the first bar 6a, and the third bar 7 extending in a plus X direction as a second direction intersecting the first direction and coupling the first bar 6a and the second bar 6b. In a preferred example, the movable body 8 is configured such that a mass of the third bar 7 is larger than that of the first bar 6a and the second bar 6b, in other words, a front end of the movable body 8 is heavier. The configuration is to increase a moment of inertia about the swing axis 61.

With such a configuration, the sensor element 50 is configured as an acceleration sensor having a so-called one-side seesaw structure in which the movable body 8 swings about the swing axis 61.

### Detection Principle of Acceleration

The third bar 7 is provided with a movable comb electrode group 20. The movable comb electrode group 20 includes a movable electrode group 20a and a movable electrode group 20b. The movable electrode group 20a and the movable electrode group 20b are provided at bilaterally symmetrical positions with respect to a central axis 62, as a target axis, extending in a Y axis direction. The movable electrode group 20a includes four movable electrodes 21 extending from the third bar 7 in a minus Y direction. The four movable electrodes 21 are provided in a comb shape at an equal pitch along an extending direction of the third bar 7. Similarly, the movable electrode group 20b includes four movable electrodes 22 extending from the third bar 7 in the minus Y direction. The four movable electrodes 22 are provided in a comb shape at an equal pitch along the extending direction of the third bar 7. The number of the movable electrodes 21 and 22 is not limited to four, and may be plural, for example, eight or ten.

The base body 1 is provided with a fixed comb electrode group 10 facing the movable comb electrode group 20. The fixed comb electrode group 10 includes a fixed electrode group 10a and a fixed electrode group 10b. The fixed electrode group 10a includes a pedestal portion 9a provided on the base body 1 and three fixed electrodes 11 extending from the pedestal portion 9a in the plus Y direction. The three fixed electrodes 11 are provided in a comb shape at an equal pitch to be housed in gaps among the four movable electrodes 21 in the movable electrode group 20a. Accordingly, the fixed electrode 11 and the movable electrode 21 face each other in an extending direction of the X axis.

Similarly, the fixed electrode group 10b includes a pedestal portion 9b provided on the base body 1 and three fixed electrodes 12 extending from the pedestal portion 9b in the plus Y direction. The three fixed electrodes 12 are provided in a comb shape at an equal pitch to be housed in gaps among the four movable electrodes 22 in the movable electrode group 20b. Accordingly, the fixed electrode 12 and the movable electrode 22 face each other in the extending direction of the X axis. The number of the fixed electrodes 11 and 12 is not limited to three, and may be any number corresponding to the number of the movable electrodes 21 and 22. For example, when the number of the movable electrodes 21 is eight, the number of the fixed electrodes 11 is seven.

FIG. 3 is a perspective view showing a three-dimensional shape of a comb electrode group, and is a perspective view of the fixed electrode group 10a and the movable electrode group 20a.

As shown in FIG. 3, the movable electrode 21 is partially recessed in thickness in the Y axis direction. Specifically, in the movable electrode 21, a thickness of a portion indicated by a range a is reduced in the Y axis direction. In other words, the movable electrode 21 is cut out stepwise in the middle in the minus Y direction from the same thickness as the third bar 7 at the root and grows thin. Accordingly, thicknesses of the four movable electrodes 21 on a plus Z side are reduced in portions facing the fixed electrodes 11 of the fixed electrode group 10a.

A detector including the fixed electrode group 10a and the movable electrode group 20a is referred to as an N-type detector 25n. In the N-type detector 25n, a parallel plate type capacitance is constituted by the fixed electrode 11 and the movable electrode 21 facing each other. The capacitance changes in accordance with a change in an overlapping area between the fixed electrode 11 and the movable electrode 21 in accordance with displacement of the movable electrode 21 due to the acceleration.

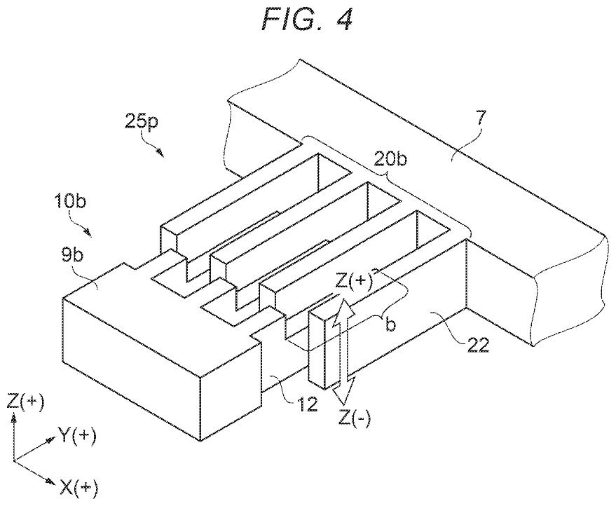

FIG. 4 is a perspective view showing a three-dimensional shape of a comb electrode group, and is a perspective view of the fixed electrode group 10b and the movable electrode group 20b.

As shown in FIG. 4, the fixed electrode 12 is partially recessed in thickness in the Y axis direction. Specifically, in the fixed electrode 12, a thickness of a portion indicated by a range b is reduced in the Y axis direction. In other words, the fixed electrode 12 is cut out stepwise in the middle in the plus Y direction from the same thickness as the pedestal portion 9b at the root and grows thin. Accordingly, thicknesses of the three fixed electrodes 12 on the plus Z side are reduced in portions facing the movable electrodes 22 of the movable electrode group 20b.

A detector including the fixed electrode group 10b and the movable electrode group 20b is referred to as a P-type detector 25p. In the P-type detector 25p, a parallel plate type capacitance is constituted by the fixed electrode 12 and the movable electrode 22 facing each other. The capacitance changes in accordance with a change in an overlapping area between the fixed electrode 12 and the movable electrode 22 in accordance with displacement of the movable electrode 22 due to the acceleration.

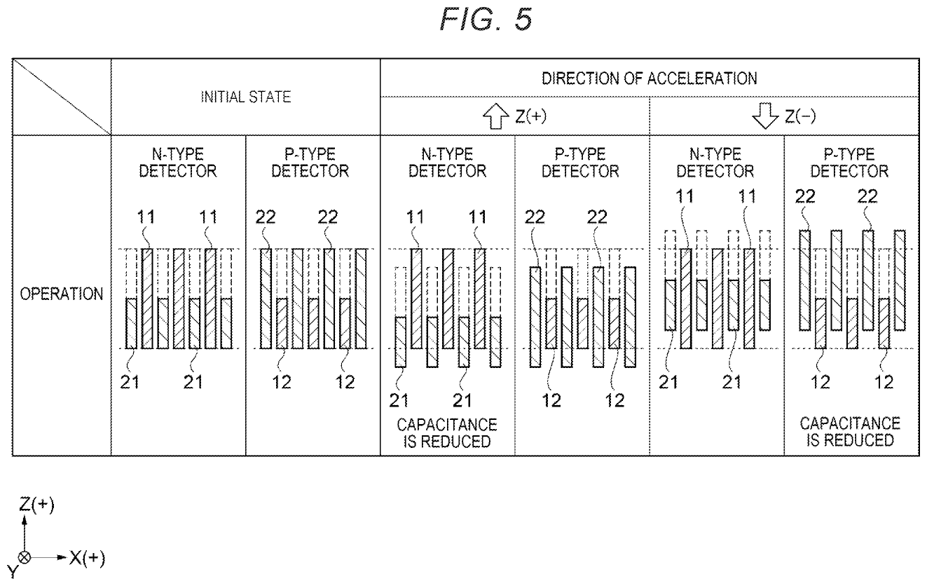

FIG. 5 is a diagram of a detection principle in the sensor element.

In FIG. 5, an initial state is shown on the left side, and a case in which a direction of the acceleration is a plus Z direction and a case in which the direction of the acceleration is a minus Z direction are shown as a state in which the acceleration is generated on the right side. Specifically, FIG. 5 shows a degree of overlap between the fixed electrode 11 and the movable electrode 21 and a degree of overlap between the fixed electrode 12 and the movable electrode 22 in a cross section along an XZ plane. The initial state is a state in which the acceleration including the gravity is not generated in the plus Z direction and the minus Z direction. Hereinafter, the plus Z direction and the minus Z direction are also referred to as a plus/minus Z direction.

First, in the initial state, in the N-type detector 25n, positions of end portions of the fixed electrode 11 and the movable electrode 21 on a minus Z side coincide with each other and are flush with each other. Similarly, in the P-type detector 25p, positions of end portions of the fixed electrode 12 and the movable electrode 22 on the minus Z side coincide with each other and are flush with each other. The overlapping area between the fixed electrode 11 and the movable electrode 21 in the initial state and the overlapping area between the fixed electrode 12 and the movable electrode 22 in the initial state are also referred to as an initial area.

Next, when the acceleration in the plus Z direction is generated, the movable electrode 21 of the N-type detector 25n and the movable electrode 22 of the P-type detector 25p are displaced to the minus Z side by receiving an inertial force accompanying the acceleration. At this time, the overlapping area between the fixed electrode 11 and the movable electrode 21 in the N-type detector 25n is smaller than the initial area due to the displacement of the movable electrode 21 in the minus Z direction. On the other hand, in the P-type detector 25p, the overlapping area between the fixed electrode 12 and the movable electrode 22 is maintained at the initial area even when the movable electrode 22 is displaced in the minus Z direction. In other words, even when the movable electrode 22 is displaced in the minus Z direction, the overlapping area is maintained constant.

As described above, when the acceleration is generated in the plus Z direction, the overlapping area in the N-type detector 25n is reduced, and the overlapping area in the P-type detector 25p is maintained.

Next, when the acceleration in the minus Z direction is generated, the movable electrode 21 of the N-type detector 25n and the movable electrode 22 of the P-type detector 25p are displaced to the plus Z side by receiving the inertial force accompanying the acceleration. At this time, the overlapping area between the fixed electrode 11 and the movable electrode 21 in the N-type detector 25n is maintained at the initial area even when the movable electrode 21 is displaced in the plus Z direction. On the other hand, the overlapping area between the fixed electrode 12 and the movable electrode 22 in the P-type detector 25p is smaller than the initial area due to the displacement of the movable electrode 22 in the plus Z direction.

As described above, when the acceleration in the minus Z direction is generated, the overlapping area in the N-type detector 25n is maintained, and the overlapping area in the P-type detector 25p is reduced.

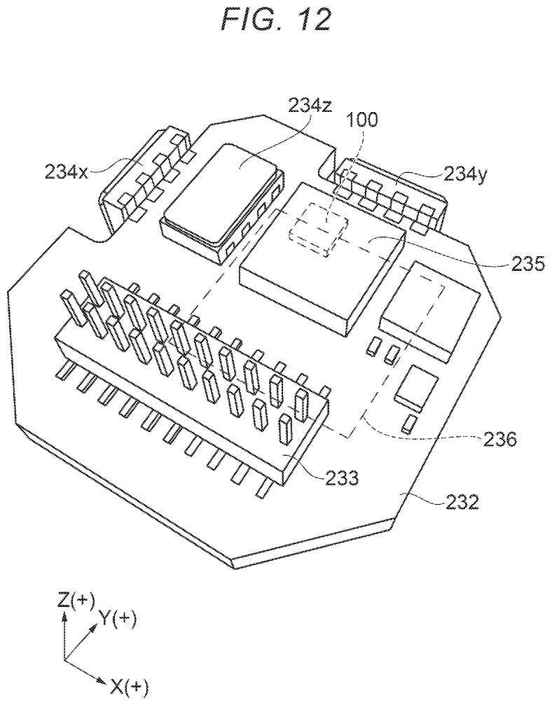

Based on the correlation described above, the acceleration in the plus/minus Z direction can be detected by detecting a change in the overlapping area in the N-type detector 25n and the P-type detector 25p as a change in the capacitance. Specifically, the acceleration in the plus/minus Z direction can be detected by detecting a difference between the capacitance of the N-type detector 25n and the capacitance of the P-type detector 25p using a differential amplifier circuit. The differential amplifier circuit is incorporated in a control IC 236 (FIG. 12) to be described later. When the acceleration is detected, an AC detection signal is used.

In the above description, a configuration in which cutout portions are provided in the movable electrode 21 and the fixed electrode 12 is described, and the present disclosure is not limited to this configuration. For example, a configuration in which cutout portions are provided in the fixed electrode 11 and the movable electrode 22 may be adopted.

The description returns to FIG. 1.

One side of the base body 1 on a plus X side protrudes from the lid body 5, and a plurality of coupling pads are provided in the protruding portion.

A coupling pad 41 is electrically coupled to the fixed electrode group 10b of the P-type detector 25p by a wiring 71.

A coupling pad 42 is electrically coupled to the fixed electrode group 10a of the N-type detector 25n by a wiring 72.

A coupling pad 44 is electrically coupled to the movable body 8, which includes the movable comb electrode group 20 and a first inspection electrode 30, by a wiring 74.

The coupling pads 41, 42, and 44 are electrically coupled to the control IC 236 (FIG. 12) via a wiring such as a bonding wire (not shown).

### Configuration of Inspection Electrode

The movable body 8 is provided with the first inspection electrode 30. Specifically, the first inspection electrode 30 having a substantially rectangular shape is provided between the movable electrode group 20a and the movable electrode group 20b in the third bar 7.

The first inspection electrode 30 is provided such that a long side thereof extends from the third bar 7 in the minus Y direction. The first inspection electrode 30 has a shape capable of maintaining rigidity in all of an X axis direction, the Y axis direction, and the Z axis direction, and has a large area in order to maximize an electrostatic attraction.

As shown in FIG. 1, the first inspection electrode 30 is provided with a plurality of damping adjustment holes 31 in a plan view. The damping adjustment holes 31 will be described later.

As shown in FIG. 2, a second inspection electrode 15 facing the first inspection electrode 30 is provided on the bottom surface of the lid body 5.

As shown in FIG. 1, the second inspection electrode 15 has a substantially rectangular shape in a plan view, and is provided at a position overlapping the first inspection electrode 30. The present disclosure is not limited to the configuration in which the second inspection electrode 15 is provided on the lid body 5, and may have a configuration in which the second inspection electrode 15 faces the first inspection electrode 30. For example, the second inspection electrode 15 may be provided on the bottom surface of the recess 1b of the base body 1. In other words, the sensor element 50 includes the first inspection electrode 30 provided on the movable body 8, and the second inspection electrode 15 provided on the base body 1 or the lid body 5 and overlapping the first inspection electrode 30 in a plan view of the base body 1.

A coupling pad 43 that is electrically coupled to the second inspection electrode 15 is provided on the protruding portion of the base body 1 on the plus X side. The second inspection electrode 15 and the coupling pad 43 are electrically coupled by a wiring 73.

The coupling pad 43 is electrically coupled to the control IC 236 (FIG. 12) via a wiring such as a bonding wire (not shown).

### Form of Damping Adjustment Hole

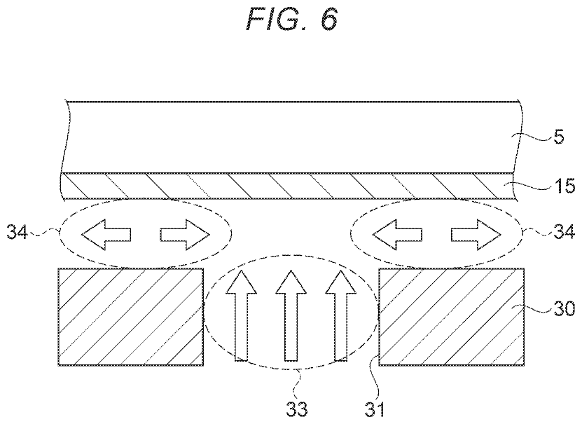

FIG. 6 is an enlarged view of a portion d in FIG. 2.

A detection function of the acceleration sensor 100 can be checked by applying a DC signal for inspection between the first inspection electrode 30 and the second inspection electrode 15, generating an electrostatic attraction therebetween, and swinging the movable body 8. On the other hand, when the movable body 8 swings, damping of gas occurs in the housing space S. The damping adjustment hole 31 of the first inspection electrode 30 is provided to reduce the damping.

As shown in FIG. 6, the damping between the first inspection electrode 30 and the second inspection electrode 15 is divided into in-hole damping 33 of the gas passing through the damping adjustment hole 31 and squeeze film damping 34 between the first inspection electrode 30 and the second inspection electrode 15.

In the in-hole damping 33, when the damping adjustment hole 31 is enlarged, the gas easily passes through the damping adjustment hole 31, and the damping can be reduced. In the squeeze film damping 34, an occupancy of the damping adjustment hole 31 in an area of the first inspection electrode 30 increases, a facing area between the first inspection electrode 30 and the second inspection electrode 15 decreases, and thus the damping can be reduced. On the other hand, when the damping adjustment hole 31 is enlarged or the occupancy is increased, a mass of the first inspection electrode 30 is reduced, and thus the front end of the movable body 8 is lightened and detection sensitivity of the acceleration is lowered. As described above, the detection sensitivity and the damping are in a trade-off relationship.

The damping adjustment hole 31 of the first inspection electrode 30 is provided with a balance between the detection sensitivity and the damping. Specifically, the plurality of damping adjustment holes 31 are disposed such that a difference between the in-hole damping 33 and the squeeze film damping 34 is as small as possible, and preferably such that the in-hole damping 33 and the squeeze film damping 34 are equal to each other. In a preferred example, the occupancy of the damping adjustment holes 31 in the area of the first inspection electrode 30 is preferably 75% or more, more preferably 78% or more, and still more preferably 82% or more. The damping adjustment holes 31 preferably have a square shape. A polygon having an area within ±25% of the area of the square may be used. The first inspection electrode 30 is bilaterally symmetrical with respect to a central axis 62 as a target axis. The arrangement of the plurality of damping adjustment holes 31 is also bilaterally symmetrical.

### Inspection Method of Acceleration Sensor

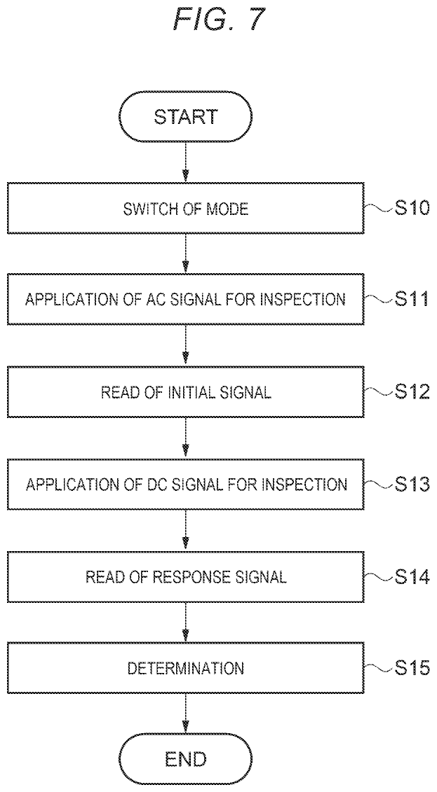

FIG. 7 is a flowchart showing a flow of an inspection method of the detection function of the acceleration sensor.

Next, the inspection method of the detection function in the acceleration sensor 100 will be described mainly with reference to FIG. 7 and with reference to FIG. 1 appropriately. The inspection method of FIG. 7 is performed by the control IC executing an inspection program stored in a storage attached to the control IC 236 (FIG. 12). The inspection of the detection function is performed in a stationary state in which the acceleration is not applied to the acceleration sensor 100.

In step S10, the acceleration sensor 100 is switched from an acceleration detection mode to a detection function inspection mode.

In step S11, in order to obtain a detection value in the initial state, a weak AC signal for inspection is applied to the acceleration sensor 100. At this time, a potential of the movable body 8 including the movable comb electrode group 20 and the first inspection electrode 30, a potential of the fixed electrode group 10b of the P-type detector 25p, and a potential of the fixed electrode group 10a of the N-type detector 25n are all set to a common GND potential, and a state in which an electrostatic attraction is not generated inside the acceleration sensor 100 is maintained.

In step S12, inspection data based on the capacitance between the first inspection electrode 30 and the second inspection electrode 15 is read. The inspection data is stored as an initial value.

In step S13, a DC signal for inspection is superimposed on an inspection electrode. In a preferred example, a DC voltage of about 3 V to 5 V is superimposed between the first inspection electrode 30 and the second inspection electrode 15. Specifically, a potential of the first inspection electrode 30 may be maintained at the GND potential, and a potential of the second inspection electrode 15 may be set to 5 V, or the two potentials may be reversed. Accordingly, an electrostatic attraction is generated between the first inspection electrode 30 and the second inspection electrode 15, and the movable body 8 swings and is displaced.

In step S14, inspection data based on the capacitance between the first inspection electrode 30 and the second inspection electrode 15 accompanying the displacement of the movable body 8 is read. The inspection data is stored as an inspection value.

In step S15, it is determined whether the detection function is functioning. Specifically, it is determined whether a difference between the initial value and the inspection value is equal to or greater than a preset value. When the difference is equal to or greater than the preset value, it is determined that the detection function is functioning, and the inspection mode is ended. When the difference is less than the preset value, a flag of an inspection failure is notified.

As described above, according to the acceleration sensor 100 of the embodiment, the following effects can be obtained.

The acceleration sensor 100 as the inertial sensor includes: the base body 1; the sensor element 50 provided at the base body 1; and the lid body 5 covering the sensor element 50. The sensor element 50 includes the anchor 3 fixed to the base body 1, the movable body 8 rotatable about the swing axis 61 as the first axis horizontal to the base body 1, the first rotation spring 4a and the second rotation spring 4b coupling the anchor 3 and the movable body 8, the movable comb electrode group 20 provided at the movable body 8, the fixed comb electrode group 10 provided at the base body 1 and facing the movable comb electrode group 20, the first inspection electrode 30 provided at the movable body 8, and the second inspection electrode 15 provided at the base body 1 or the lid body 5 and overlapping the first inspection electrode 30 in the plan view of the base body 1. In the plan view, the first inspection electrode 30 is provided with the plurality of damping adjustment holes 31.

Accordingly, the acceleration sensor 100 includes the first inspection electrode 30 and the second inspection electrode 15 for inspecting a sensor function. The plurality of damping adjustment holes 31 are provided in the first inspection electrode 30. The damping adjustment holes 31 obtain necessary detection sensitivity while preventing the damping. Therefore, noise caused by the damping can be reduced, and sensor function inspection can be easily performed.

Therefore, it is possible to provide the acceleration sensor 100 as the inertial sensor capable of easily inspecting the movable body without deteriorating the noise characteristics.

The movable body 8 includes the first bar 6a extending from the first rotation spring 4a in the plus Y direction as the first direction, the second bar 6b extending from the second rotation spring 4b in the plus Y direction and paired with the first bar 6a, and the third bar 7 extending in the plus X direction as the second direction intersecting the plus Y direction and coupling the first bar 6a and the second bar 6b. The first inspection electrode 30 is provided at the third bar 7.

Accordingly, since the first inspection electrode 30 having a constant mass is provided at the front end of the movable body 8, it is possible to increase a rotational moment when an acceleration is applied.

Therefore, the acceleration sensor 100 having high detection sensitivity can be provided.

When a target axis, in which the first bar 6a and the second bar 6b are line-symmetric, is set as the central axis 62 as a second axis, the first inspection electrode 30 is line-symmetric with respect to the central axis 62.

The damping adjustment holes 31 are line-symmetric with respect to the central axis 62.

Accordingly, the first inspection electrode 30 is bilaterally symmetrical with respect to the central axis 62 as the target axis. Therefore, an unnecessary vibration mode against an external impact and the like can be reduced. In particular, an unnecessary inertial force in the X axis direction can be reduced.

Therefore, the acceleration sensor 100 having high reliability can be provided.

### Second Embodiment

### Different Aspect of Sensor Element-1

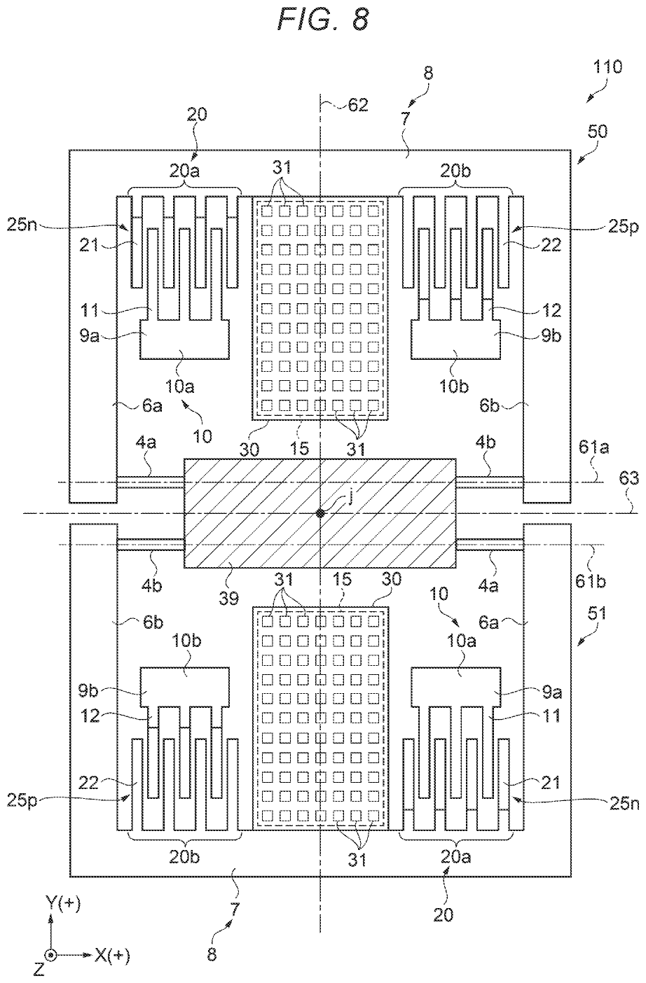

FIG. 8 is a plan view of a sensor element according to a second embodiment, and corresponds to FIG. 1.

In the above embodiment, the acceleration sensor 100 including the sensor element 50 having a one-side seesaw structure, in which a front end side of the movable body 8 in the plus Y direction swings about the swing axis 61, was described. The present disclosure is not limited to this configuration, and may have a both-side seesaw structure. For example, in an acceleration sensor 110 of the embodiment, another sensor element 51 is provided in the minus Y direction, and a both-side seesaw structure is adopted. Hereinafter, the same reference numerals are given to the same portions as those of the above-described embodiment, and redundant description thereof will be omitted.

As shown in FIG. 8, the acceleration sensor 110 of the embodiment includes the sensor element 51 as a second sensor element in the minus Y direction, in addition to the sensor element 50 as a first sensor element. In FIG. 8, illustration of the base body 1 and the lid body 5 is omitted, and only the sensor elements 50 and 51 are shown.

The sensor element 51 has the same configuration as that of the sensor element 50, but has a different arrangement posture. The sensor element 51 is disposed in a posture in which the sensor element 50 is rotated by 180° about a center point j in an XY plane. A anchor 39 is provided in common to the sensor elements 50 and 51, and a center thereof is the center point j. A line segment passing through the center point j and extending along the X axis is defined as a partition line 63. In other words, the sensor element 51 is disposed in a posture rotated by 180° in the XY plane including a swing axis 61a as the first axis and the central axis 62 as a second axis.

The sensor element 50 is disposed on a plus Y side and the sensor element 51 is disposed on a minus Y side with the partition line 63 as a boundary line. In other words, the sensor element 50 and the sensor element 51 are arranged side by side along the central axis 62. Two swing axes 61a and 61b pass through the anchor 39. The sensor element 50 has a one-side seesaw structure in which the front end side of the movable body 8 in the plus Y direction swings about the swing axis 61a. The sensor element 51 has a one-side seesaw structure in which the front end side of the movable body 8 in the minus Y direction swings about the swing axis 61b. Accordingly, the acceleration sensor 110 having a both-side seesaw structure is implemented.

In the acceleration sensor 110, the N-type detector 25n of the sensor element 50 and the N-type detector 25n of the sensor element 51 are disposed at diagonal positions. Similarly, the P-type detector 25p of the sensor element 50 and the P-type detector 25p of the sensor element 51 are disposed at diagonal positions. Accordingly, detection accuracy can be improved by averaging detection data of the sensor element 50 and detection data of the sensor element 51.

The plurality of damping adjustment holes 31 are provided in each of the first inspection electrodes 30 of the sensor elements 50 and 51.

As described above, according to the acceleration sensor 110 of the embodiment, the following effects can be obtained in addition to the effects of the first embodiment.

The acceleration sensor 110 includes the sensor element 50 as the first sensor element and the sensor element 51 as the second sensor element having the same configuration as the sensor element 50. The sensor element 51 is disposed in a posture rotated by 180° in the XY plane including the swing axis 61a as the first axis and the central axis 62 as the second axis. The sensor element 50 and the sensor element 51 are arranged side by side along the central axis 62.

The acceleration sensor 110 includes the first inspection electrode 30 and the second inspection electrode 15 for inspecting a sensor function. The plurality of damping adjustment holes 31 are provided in the first inspection electrode 30.

Therefore, it is possible to provide the acceleration sensor 110 as the inertial sensor capable of easily inspecting the movable body without deteriorating the noise characteristics.

Further, since the two sensor elements 50 and 51 having different postures are provided, the detection accuracy can be improved by averaging the detection data of the two sensor elements.

### Third Embodiment

### Different Aspect of Sensor Element-2

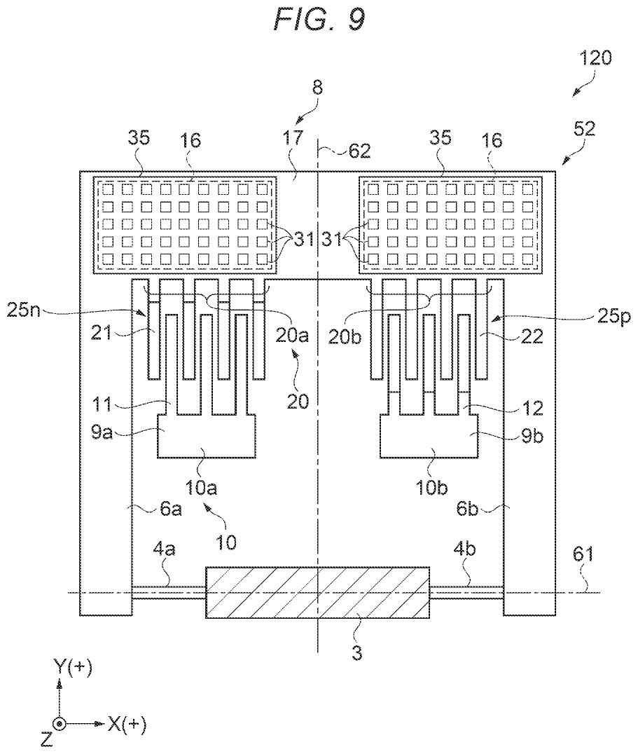

FIG. 9 is a plan view of a sensor element according to a third embodiment, and corresponds to FIG. 1. In FIG. 9, illustration of the base body 1 and the lid body 5 is omitted, and only a sensor element 52 is shown.

In the embodiment described above, the first inspection electrode 30 protrudes from the third bar 7 of the movable body 8 in the minus Y direction. The present disclosure is not limited to this configuration, and the movable body 8 may be provided with the first inspection electrode. For example, in an acceleration sensor 120 of the embodiment, first inspection electrodes 35 are provided at positions overlapping a third bar 17 of the movable body 8.

Hereinafter, the same reference numerals are given to the same portions as those of the above-described embodiment, and redundant description thereof will be omitted.

As shown in FIG. 9, in the sensor element 52 of the acceleration sensor 120 in the embodiment, the third bar 17 of the movable body 8 has a large width, and two first inspection electrodes 35 are provided at the positions overlapping the third bar 17. In other words, the first inspection electrodes 35 are provided on the third bar 17.

Since the first inspection electrodes 35 do not protrude from the third bar 17, there is no other component between the movable electrode group 20a and the movable electrode group 20b, and a distance between the movable electrode group 20a and the movable electrode group 20b is shorter than that in FIG. 1. Along with this, a length of the entire movable body 8 in the X axis direction is also shortened.

The first inspection electrode 35 has a rectangular shape, and a long side direction thereof coincides with an extending direction of the third bar 17. The first inspection electrode 35 is provided with the plurality of substantially square damping adjustment holes 31. As described above, the plurality of damping adjustment holes 31 are disposed in a balance between the detection sensitivity and the damping. The lid body 5 (FIG. 1) is provided with second inspection electrodes 16 at positions overlapping the first inspection electrodes 35.

The first inspection electrodes 35 are provided at two positions to be bilaterally symmetrical with respect to the central axis 62 as a target line. The number of positions is not limited to two as long as the first inspection electrodes 35 and the damping adjustment holes 31 are bilaterally symmetrical. For example, one first inspection electrode 35 may be provided at a center of the third bar 17, or two first inspection electrodes 35 may be provided at left and right sides of the third bar 17. The second inspection electrodes 16 are also bilaterally symmetrical with respect to the central axis 62 as a target line.

As described above, according to the acceleration sensor 120 of the embodiment, the following effects can be obtained in addition to the effects of the above embodiments.

The acceleration sensor 120 includes the first inspection electrode 35 provided at the position overlapping the third bar 17 and the second inspection electrode 16 provided at the position overlapping the first inspection electrode 35. The sensor function can be inspected by applying an inspection signal between the first inspection electrode 35 and the second inspection electrode 16. The plurality of damping adjustment holes 31 are provided in the first inspection electrode 35.

Further, since the first inspection electrode 35 does not protrude from the third bar 17, the acceleration sensor 120 can be compact.

Therefore, it is possible to provide the acceleration sensor 120 as the inertial sensor which is small in size and can easily inspect the movable body without deteriorating the noise characteristics.

### Fourth Embodiment

### Different Aspect of Sensor Element-3

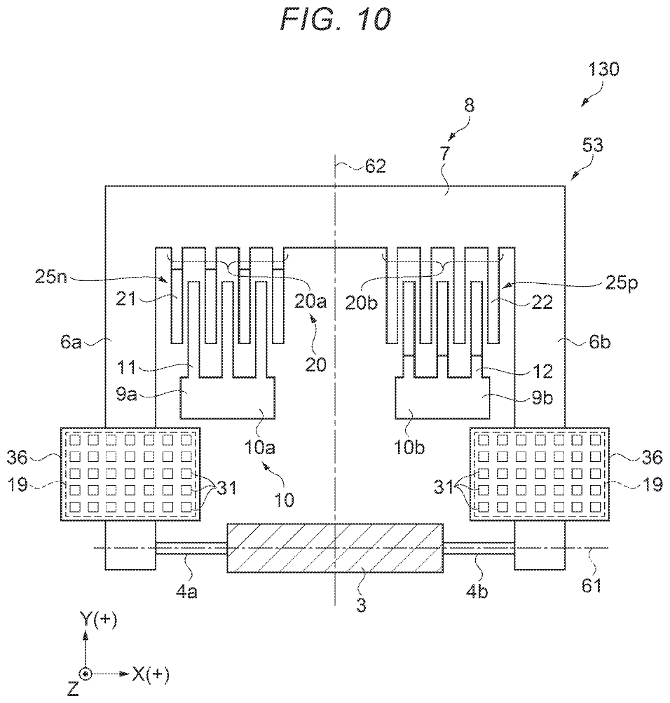

FIG. 10 is a plan view of a sensor element according to a fourth embodiment, and corresponds to FIGS. 1 and 9. In FIG. 10, illustration of the base body 1 and the lid body 5 is omitted, and only a sensor element 53 is shown.

In the embodiment described above, the first inspection electrode 30 protrudes from the third bar 7 of the movable body 8 in the minus Y direction. The present disclosure is not limited to this configuration, and the movable body 8 may be provided with the first inspection electrode. For example, in an acceleration sensor 130 of the embodiment, a first inspection electrode 36 is provided on each of the first bar 6a and the second bar 6b of the movable body 8. Hereinafter, the same reference numerals are given to the same portions as those of the above-described embodiment, and redundant description thereof will be omitted.

As shown in FIG. 10, in the sensor element 53 of the acceleration sensor 130 in the embodiment, the first inspection electrode 36 is provided on a swing axis 61 side of the first bar 6a of the movable body 8, and the first inspection electrode 36 is also provided on the swing axis 61 side of the second bar 6b. In other words, the first inspection electrode 36 is provided on the first bar 6a and the second bar 6b.

The first inspection electrode 36 has a rectangular shape, and is provided such that a long side direction thereof intersects the extending direction of the first bar 6a. Both ends of the first inspection electrode 36 in the long side direction protrude from the first bar 6a. The first inspection electrode 36 is provided with the plurality of substantially square damping adjustment holes 31. As described above, the plurality of damping adjustment holes 31 are disposed in a balance between the detection sensitivity and the damping. The lid body 5 (FIG. 1) is provided with second inspection electrodes 19 at positions overlapping the first inspection electrodes 36.

The first inspection electrodes 36 are bilaterally symmetrical at two positions of the first bar 6a and the second bar 6b with respect to the central axis 62 as a target line. The second inspection electrodes 19 are also bilaterally symmetrical with respect to the central axis 62 as the target line.

As described above, according to the acceleration sensor 130 of the embodiment, the following effects can be obtained in addition to the effects of the above embodiments.

The acceleration sensor 130 includes the first inspection electrodes 36 provided at the first bar 6a and the second bar 6b of the movable body 8, and the second inspection electrodes 19 respectively paired with the first inspection electrodes 36. The sensor function can be inspected by applying an inspection signal between the first inspection electrodes 36 and the second inspection electrodes 19. The plurality of damping adjustment holes 31 are provided in the first inspection electrode 36. Therefore, it is possible to provide the acceleration sensor 130 as the inertial sensor capable of easily inspecting the movable body without deteriorating the noise characteristics.

### Fifth Embodiment

### Inertial Measurement Unit

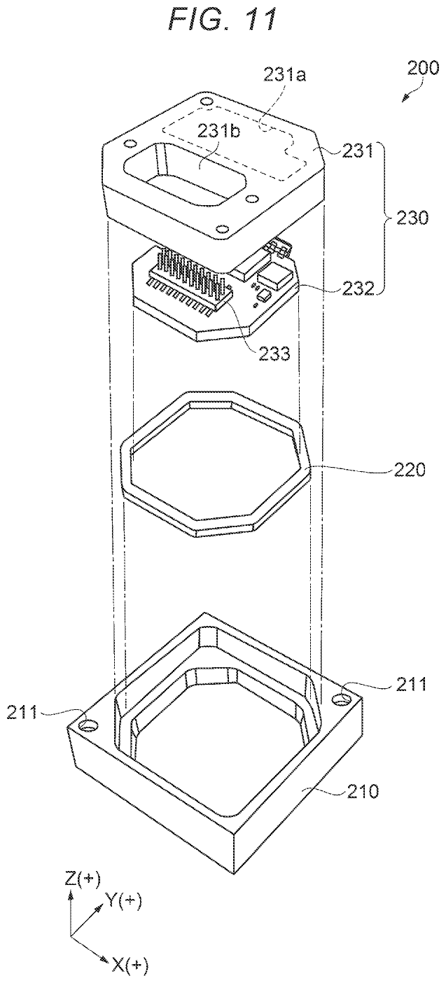

FIG. 11 is an exploded perspective view of an inertial measurement unit according to a fifth embodiment. FIG. 12 is a perspective view of a circuit substrate. Next, an example of an inertial measurement unit 200 according to the embodiment will be described with reference to FIGS. 11 and 12.

The inertial measurement unit (IMU) 200 shown in FIG. 11 is a unit that detects an inertial movement amount of a posture or a behavior of a moving body such as an automobile or a robot, or the like. A mount body is not limited to a moving body such as an automobile, and may be, for example, a building such as a bridge or an elevated track. When the inertial measurement unit 200 is attached to a building, the inertial measurement unit 200 is used as a structural health monitoring system that checks health of the building.

The inertial measurement unit 200 is a so-called six-axis motion sensor including an acceleration sensor that detects accelerations in directions along three axes and an angular velocity sensor that detects angular velocities around three axes.

The inertial measurement unit 200 is a rectangular parallelepiped having a substantially square planar shape. Screw holes 211 are formed in the vicinity of two vertexes located in a diagonal direction of the square. Two screws can be inserted into the two screw holes 211 to fix the inertial measurement unit 200 to a mount surface of a mount body such as an automobile. It is also possible to reduce a size to a degree that can be mounted on, for example, a smartphone or a digital camera by selecting a component or changing a design.

The inertial measurement unit 200 includes an outer case 210, a bonding member 220, and a sensor module 230, and has a configuration in which the sensor module 230 is inserted inside the outer case 210 with the bonding member 220 interposed therebetween. The sensor module 230 includes an inner case 231 and a circuit substrate 232. The inner case 231 is provided with a recess 231a for preventing contact with the circuit substrate 232 and an opening 231b for exposing a connector 233 to be described later. The circuit substrate 232 is bonded to a lower surface of the inner case 231 via an adhesive.

As shown in FIG. 12, the connector 233, an angular velocity sensor 234z that detects an angular velocity around the Z axis, an acceleration sensor unit 235 that detects an acceleration in each axial direction of the X axis, the Y axis, and the Z axis, and the like are mounted on an upper surface of the circuit substrate 232.

An angular velocity sensor 234x that detects an angular velocity around the X axis and an angular velocity sensor 234y that detects an angular velocity around the Y axis are mounted on a side surface of the circuit substrate 232.

The acceleration sensor unit 235 includes at least the acceleration sensor 100 for measuring the acceleration in the Z axis direction described above, and can detect an acceleration in one axial direction or accelerations in two axial directions or three axial directions as necessary. The acceleration sensors 110, 120, and 130 may be used instead of the acceleration sensor 100.

The angular velocity sensors 234x, 234y, and 234z are not particularly limited, and for example, a vibration gyro sensor using a Coriolis force can be used.

The control IC 236 as a controller is mounted on a lower surface of the circuit substrate 232.

The control IC 236 is, for example, a micro controller unit (MCU), includes the storage including a nonvolatile memory, an A/D converter, and the like, and controls elements of the inertial measurement unit 200. The storage stores a program defining an order and contents for detecting an acceleration and an angular velocity, an inspection program defining the inspection method of the detection function of the acceleration sensor 100, accompanying data, and the like. A plurality of electronic components are mounted on the circuit substrate 232. In other words, the inertial measurement unit 200 includes the acceleration sensor 100 as the inertial sensor, and the control IC 236 as the controller that performs control based on the detection signal output from the acceleration sensor 100.

The inertial measurement unit 200 is not limited to the configuration of FIGS. 11 and 12, and may have, for example, a configuration in which only the acceleration sensor 100 is provided as the inertial sensor without providing the angular velocity sensors 234x, 234y, and 234z. In this case, for example, by configuring the acceleration sensor 100 and the control IC 236 as one mounting package, the inertial measurement unit 200 can be provided as a one-chip mounting component.

As described above, according to the inertial measurement unit 200 of the embodiment, the following effects can be obtained in addition to the effects of the above embodiments.

The inertial measurement unit 200 includes the acceleration sensor 100 as the inertial sensor, and the control IC 236 as the controller that performs control based on the detection signal output from the acceleration sensor 100.

Accordingly, the inertial measurement unit 200 includes the acceleration sensor 100 as the inertial sensor capable of easily inspecting the movable body without deteriorating the noise characteristics. Therefore, it is possible to provide the inertial measurement unit 200 having high detection accuracy and excellent reliability.

What is claimed is:

1. An inertial sensor comprising:
a base body;
a sensor element provided at the base body; and
a lid body covering the sensor element, wherein
the sensor element includes
a anchor fixed to the base body,
a movable body swingable about a first axis, which is horizontal to the base body, as a swing axis,
a first rotation spring and a second rotation spring coupling the anchor and the movable body,
a movable comb electrode group provided at the movable body,
a fixed comb electrode group provided at the base body and facing the movable comb electrode group,
a first inspection electrode provided at the movable body, and
a second inspection electrode provided at the base body or the lid body and overlapping the first inspection electrode in a plan view, and
in the plan view, the first inspection electrode is provided with a plurality of damping adjustment holes.

2. The inertial sensor according to claim 1, wherein
the movable body includes
a first bar extending from the first rotation spring in a first direction,
a second bar extending from the second rotation spring in the first direction and paired with the first bar, and
a third bar extending in a second direction intersecting the first direction and coupling the first bar and the second bar, and
the first inspection electrode is provided at the third bar.

3. The inertial sensor according to claim 1, wherein
the movable body includes
a first bar extending from the first rotation spring in a first direction,
a second bar extending from the second rotation spring in the first direction and paired with the first bar, and
a third bar extending in a second direction intersecting the first direction and coupling the first bar and the second bar, and
the first inspection electrode is provided at the first bar and the second bar.

4. The inertial sensor according to claim 2, wherein
when a target axis serving as a reference in which the first bar and the second bar are line-symmetric is defined as a second axis, the first inspection electrode is line-symmetric with respect to the second axis.

5. The inertial sensor according to claim 4, wherein
the damping adjustment holes are line-symmetric with respect to the second axis.

6. The inertial sensor according to claim 5, further comprising:
when the sensor element is a first sensor element,
the first sensor element; and
a second sensor element having the same configuration as the first sensor element, wherein
the second sensor element is disposed in a posture rotated by 180° in a plane including the first axis and the second axis, and
the first sensor element and the second sensor element are arranged side by side along the second axis.

7. An inertial measurement unit comprising:
the inertial sensor according to claim 1; and
a controller configured to perform control based on a detection signal output from the inertial sensor.
